(19) United States
(12) Patent Application Publication
(10) Pub. No.: US 2026/0160446 A1
(43) Pub. Date: Jun. 11, 2026

(54) TANKLESS WATER HEATER INLET FILTER

(71) Applicant: Charles R. USINA, III, St. Augustine, FL (US)

(72) Inventor: Charles R. USINA, III, St. Augustine, FL (US)

(21) Appl. No.: 19/066,938

(22) Filed: Feb. 28, 2025

Related U.S. Application Data
(60) Provisional application No. 63/730,267, filed on Dec. 10, 2024.

(51) Int. Cl. F24H 9/00; B01D 29/11; B01D 29/96; F24H 1/10

(52) U.S. Cl. CPC F24H 9/0005; B01D 29/11; B01D 29/96; B01D 2201/24; B01D 2201/295; B01D 2201/4092; F24H 1/10

(57) ABSTRACT

A tankless water heater inlet filter includes a filter body having a first end and an opposing second end, and a filter cap extending outward from the first end of the filter body. The filter cap has a plurality of sidewalls to engage a socket wrench. In addition, the tankless water heater inlet filter includes threading disposed on an outer circumference of the filter body and configured to engage threading of the tankless water heater inlet, and a screen filter extending from the second end of the filter body. The tankless water heater inlet filter may also include a receptacle for receiving a rachet drive, where the receptacle comprises a square aperture, and the plurality of sidewalls of the filter cap may comprise a hexagonal shape.

### RELATED APPLICATIONS

This application claims priority to U.S. Provisional Application Ser. No. 63/730,267 filed on Dec. 10, 2024, the contents of which are herein incorporated by reference in their entirety.

### FIELD

The present invention relates to the field of tankless water heaters, and, more particularly, to a tankless water heater inlet filter.

### BACKGROUND

Tankless water heaters are becoming more popular to replace large tanks that are currently used to heat water. In contrast to existing water tank heaters, a tankless water heater instantaneously heats water as it passes through the continuous flow system. Tankless water heater assemblies are more efficient because they only heat water on demand and do not store heated water. However, a problem sometimes associated with tankless water heaters is their need for maintenance and repair. One way to reduce costly repairs is to clean or change the water inlet filter on a regular basis. However, the water inlet filter can be difficult to remove.

Accordingly, there is a need in the art for a more efficient way for removing and replacing the water inlet filter for a tankless water heater.

### SUMMARY

In view of the foregoing background, it is therefore an object of the present invention to provide a tankless water heater inlet filter. The tankless water heater inlet filter includes a filter body having a first end and an opposing second end, and a filter cap extending outward from the first end of the filter body. The filter cap has a plurality of sidewalls to engage a socket wrench. In addition, the tankless water heater inlet filter includes threading disposed on an outer circumference of the filter body and configured to engage threading of the tankless water heater inlet, and a screen filter extending from the second end of the filter body.

The filter cap of the tankless water heater inlet filter may also include a receptacle for receiving a rachet drive, where the receptacle comprises a square aperture, and the plurality of sidewalls of the filter cap may comprise a hexagonal shape. In addition, the top surface of the filter cap may have a slot defined in the top surface that is configured to engage a blade of a screwdriver and/or a pair of tabs extending outwards from opposing sidewalls of the filter cap. The top surface of the filter cap may have a cross shaped defined therein that is configured to engage a crosshead screwdriver. The top surface of the filter cap may have a plurality of raised sidewalls extending from the top surface in an “X” pattern.

In another aspect, a method to remove and install a tankless water heater inlet filter described above is disclosed. The method includes inserting the screen filter into the tankless water heater inlet, engaging the filter cap with the socket wrench, and rotating the filter cap with the socket wrench to cause the tankless water heater inlet filter to rotate to either remove or install the tankless water heater inlet filter in response to a direction of rotation.

1

### BRIEF DESCRIPTION OF THE DRAWINGS

The aspects and the attendant advantages of the embodiments described herein will become more readily apparent by reference to the following detailed description when taken in conjunction with the accompanying drawings wherein:

FIG. 1 is an exemplary tankless water heater inlet filter in accordance with the present disclosure;

FIG. 2 is a top view of the tankless water heater inlet filter of FIG. 1;

FIG. 3 is a top perspective view of the tankless water heater inlet filter of FIG. 1 having a center aperture for receiving a tool therein;

FIG. 4 is a top perspective of the tankless water heater inlet filter of FIG. 1 having a slot for receiving a flat head screw bit;

FIG. 5 is a top perspective of the tankless water heater inlet filter of FIG. 1 having a cross-shaped slot for receiving a Phillips head screw bit;

FIG. 6 is a top perspective of the tankless water heater inlet filter of FIG. 1 having two tabs or wings extending outwards;

FIG. 7 is a top perspective of the tankless water heater inlet filter of FIG. 1 where a filter cap is further elongated;

FIG. 8 is a top perspective view of the tankless water heater inlet filter of FIG. 1 having raised X-shaped tabs; and

FIG. 9 is a top perspective view of the tankless water heater inlet filter of FIG. 1 having four tabs or wings extending outward.

### DETAILED DESCRIPTION

1The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

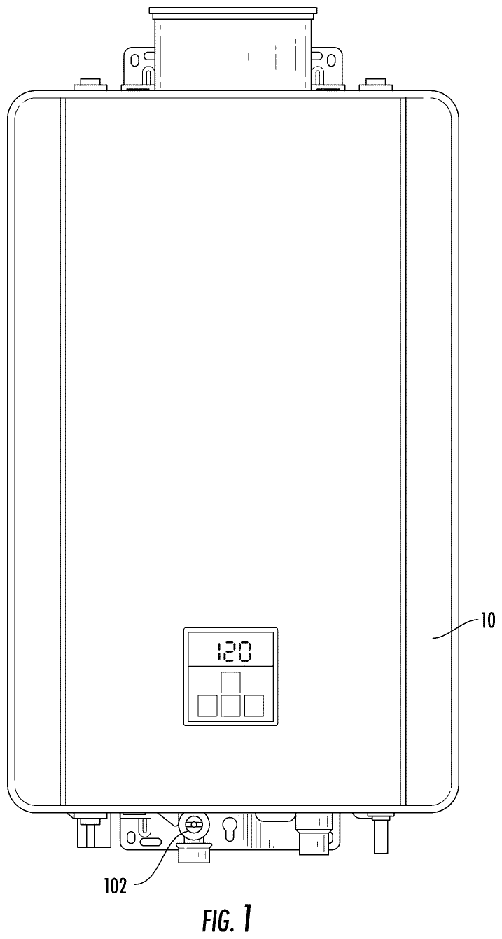

Referring now to FIG. 1, an exemplary tankless water heater 10 is depicted having a tankless inlet filter 10 for a tankless water heater is shown with a tankless water heater inlet filter of the present invention installed. The tankless water heater inlet filter is generally designated 102 and referred to hereinafter as “inlet filter.”

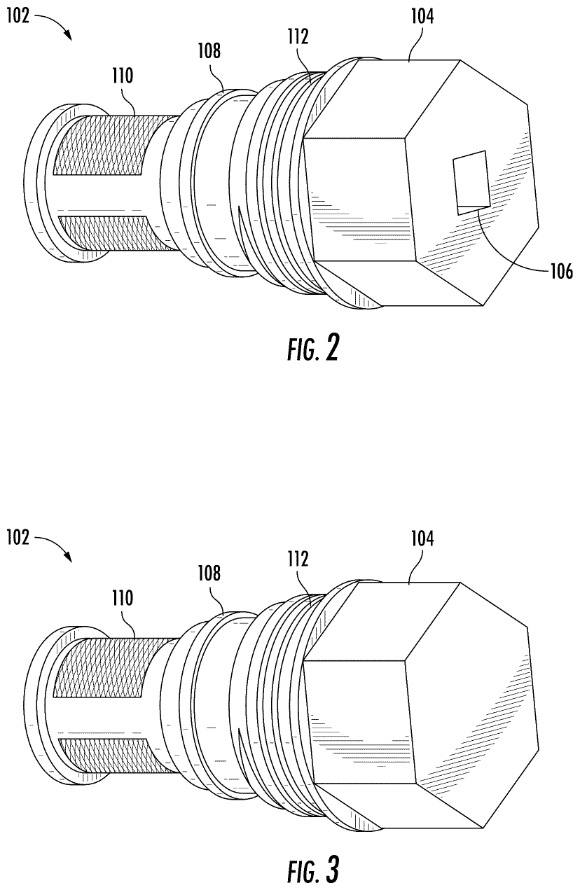

Referring now to FIGS. 2 and 3, the inlet filter 102 includes a filter cap 104 and external threading 112. The external spiral threading 112 is used to secure the inlet filter 102 within the tankless water heater 10 inlet line.

The inlet filter 102 also includes a filter body 108 having a first end and an opposing second end. The filter cap 104 extends outward from the first end of the filter body 108 and includes a plurality of sidewalls having a polygonal shape to engage a socket wrench, crescent wrench, pliers, or other device that is configured to engage a polygonal shape. The polygonal shape may comprise a hexagonal shape, for example. The filter body 108 may also be circular in shape.

The threading 112 is disposed on an outer circumference of the filter body 108 and is configured to engage threading of the tankless water heater 10 inlet line. A screen filter 110 extends from the second end of the filter body 108.

The filter cap 104 may also include a receptacle 106 for receiving a rachet drive, or other tool. In a particular aspect, the receptacle comprises a square aperture.

In another particular aspect, a method to remove and install the tankless water heater inlet filter 102 described above include inserting the screen filter 110 into the tankless water heater inlet line, and engaging the filter cap 104 with the socket wrench or other suitable tool. The method also includes rotating the filter cap 104 with the socket wrench to cause the tankless water heater inlet filter 102 to rotate to either remove or install the tankless water heater inlet filter in response to a direction of rotation.

The various aspects of the inlet filter 102 described above provide an easier way for removing and installing a tankless water heater inlet filter during maintenance. The method of installing and removing the inlet filter 102 overcomes the shortcomings of using channel locks or needle nose pliers. The inlet filter 102 allows for the safe removal and installation of the inlet filter 102 without damaging the filter cap 104 or the tankless water heater 10 itself.

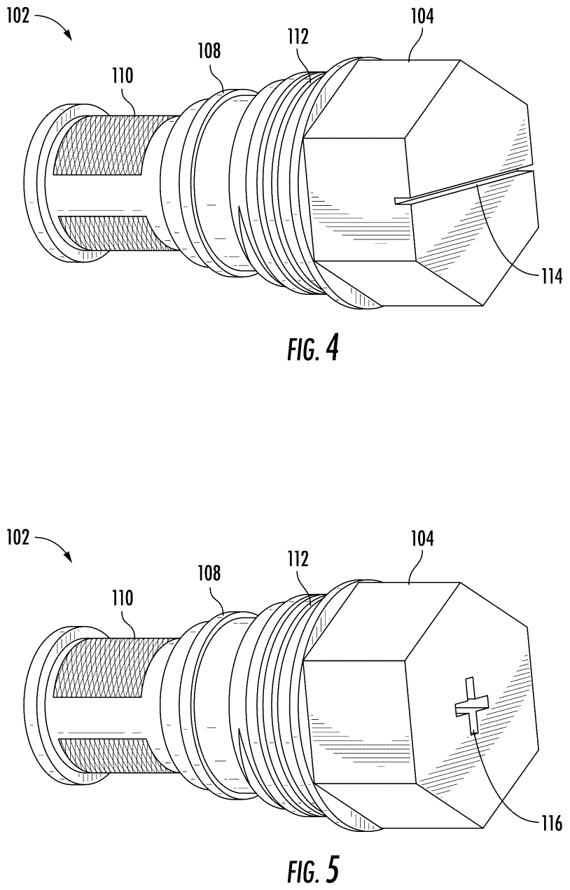

The filter cap 104 may have a slot 114 for engaging a flat head screw bit, as depicted in FIG. 4, or a cross-shaped slot 116 for engaging a Phillips head screw bit as depicted in FIG. 5, to remove the inlet filter 102. The filter body 108 may also be circular in shape.

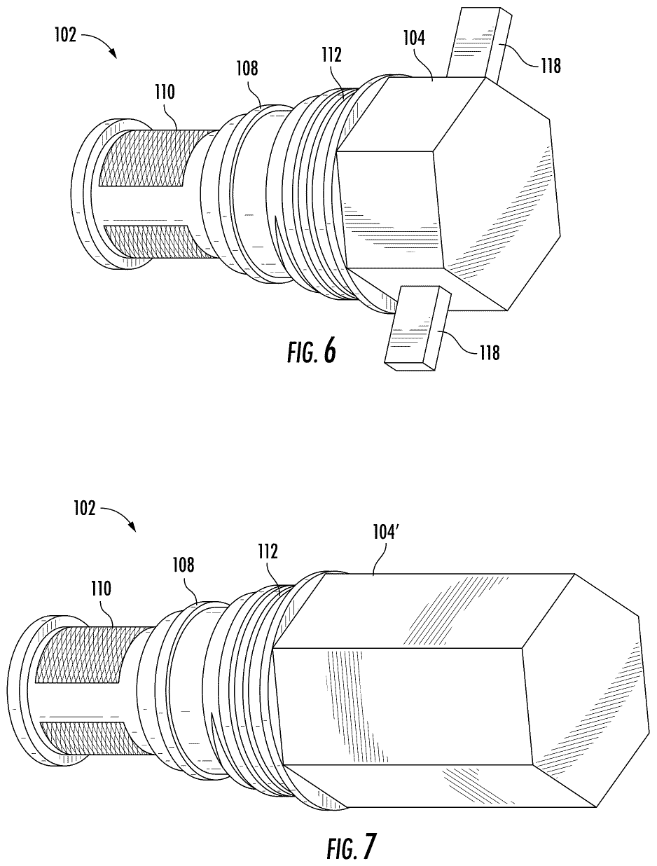

FIG. 6 is a top perspective of the tankless water heater inlet filter of FIG. 1 with the filter cap 104 having a pair of tabs 118 or wings extending outwards from opposing sides of the filter cap 104. Accordingly, a separate tool is not required to remove the inlet filter 102.

FIG. 7 is a top perspective of the tankless water heater filter of FIG. 1 with the filter cap 104 being elongated four to five inches, for example, from the threading 108.

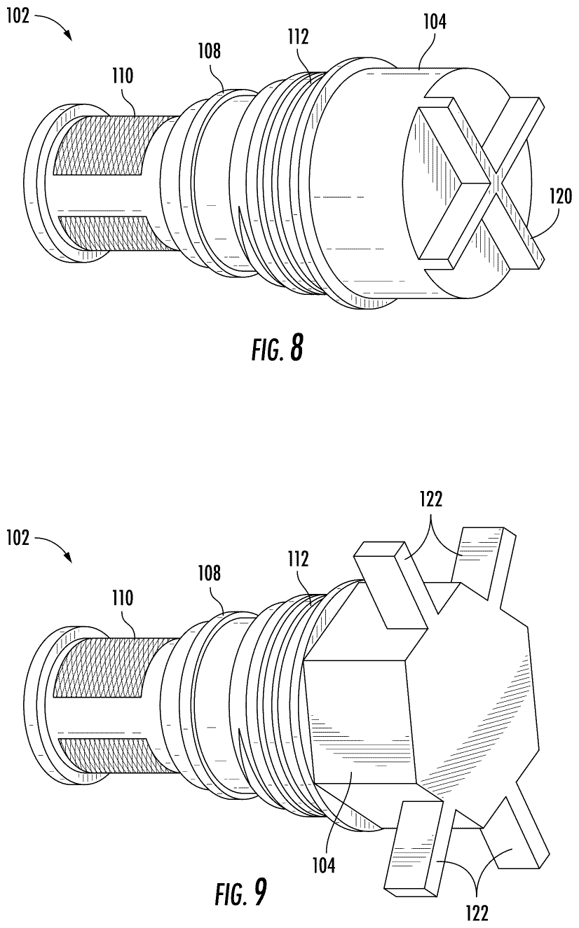

Referring now to FIG. 8, the filter cap 104 includes raised sidewalls 120 in an “X” pattern on a top surface of the filter cap. The user may grip the raised sidewalls 120 extending from the top surface and rotate the inlet filter 102.

Another example is depicted in FIG. 9, with four tabs or wings 122 extending outward from the filter cap 104 similar to that shown in FIG. 6. As those of ordinary skill in the art can appreciate, any number of tabs 122 may be used with the filter cap 104.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

1. A tankless water heater inlet filter comprising:
a filter body having a first end and an opposing second end;
a filter cap extending outward from the first end of the filter body, the filter cap comprising a plurality of sidewalls having a polygonal shape to engage a socket wrench;
threading disposed on an outer circumference of the filter body and configured to engage threading of the tankless water heater inlet; and
a screen filter extending from the second end of the filter body.

2. The tankless water heater inlet filter of claim 1, wherein the filter cap having a top surface and a receptacle defined in the top surface that is configured for receiving a rachet drive.

3. The tankless water heater inlet filter of claim 2, wherein the receptacle comprises a square aperture.

4. The tankless water heater inlet filter of claim 1, wherein the plurality of sidewalls comprise a hexagonal shape.

5. The tankless water heater inlet filter of claim 1, wherein the filter cap having a top surface and a slot defined in the top surface that is configured to engage a blade of a screwdriver.

6. The tankless water heater inlet filter of claim 1, wherein the filter cap has a pair of tabs extending outwards from opposing sidewalls of the filter cap.

7. The tankless water heater inlet filter of claim 1, wherein the filter cap having a top surface and a cross shaped defined therein that is configured to engage a crosshead screwdriver.

8. The tankless water heater inlet filter of claim 1, wherein the filter cap having a top surface and a plurality of raised sidewalls extending from the top surface in an “X” pattern.

9. A tankless water heater inlet filter comprising:
a filter body having a first end and an opposing second end;
a filter cap extending outward from the first end of the filter body, the filter cap comprising at least one sidewall and a top surface;
threading disposed on an outer circumference of the filter body and configured to engage threading of the tankless water heater inlet; and
a screen filter extending from the second end of the filter body.

10. The tankless water heater inlet filter of claim 9, wherein the top surface of the filter cap further comprises a receptacle for receiving a rachet drive.

11. The tankless water heater inlet filter of claim 10, wherein the receptacle comprises a square aperture.

12. The tankless water heater inlet filter of claim 9, wherein the at least one sidewall comprises a hexagonal shape.

13. The tankless water heater inlet filter of claim 9, wherein the top surface of the filter cap has a slot defined therein that is configured to engage a blade of a screwdriver.

14. The tankless water heater inlet filter of claim 9, wherein the filter cap further comprises a pair of tabs extending outwards from the at least one sidewall of the filter cap.

15. The tankless water heater inlet filter of claim 1, wherein the top surface of the filter cap has a cross shaped defined therein that is configured to engage a crosshead screwdriver.

16. The tankless water heater inlet filter of claim 9, wherein the top surface of the filter cap includes a plurality of raised sidewalls extending from the top surface in an “X” pattern.

17. The tankless water heater inlet filter of claim 9, wherein the top surface of the filter cap comprises a plurality of slots defined in the top surface that are configured to engage a screwdriver.

18. A method to remove and install a tankless water heater inlet filter comprising a filter body having a first end and an opposing second end, a filter cap extending outward from the first end of the filter body, the filter cap comprising a top surface and a plurality of sidewalls to engage a socket wrench, threading disposed on an outer circumference of the filter body and configured to engage threading of the tankless water heater inlet, and a screen filter extending from the second end of the filter body, the method comprising:
inserting the screen filter into the tankless water heater inlet;
engaging the filter cap with the socket wrench; and
rotating the filter cap with the socket wrench to cause the tankless water heater inlet filter to rotate to either remove or install the tankless water heater inlet filter in response to a direction of rotation.

19. The method of claim 18, wherein the top surface of the plurality of sidewalls has a plurality of raised sidewalls extending from the top surface in an “X” pattern.

20. The method of claim 18, wherein the filter cap has a pair of tabs extending outwards from opposing sidewalls of the filter cap.
